(19) United States
(12) Patent Application Publication
(10) Pub. No.: US 2021/0215326 A1
(43) Pub. Date: Jul. 15, 2021

(54) HEAD LAMP

(71) Applicant: Knog Pty Ltd, Richmond, Victoria (AU)

(72) Inventors: Tim Besley, Richmond, Victoria (AU); Michael Westwood, Richmond, Victoria (AU); Hugo Davidson, Richmond, Victoria (AU); Malcolm McKechnie, Richmond, Victoria (AU)

(73) Assignee: Knog Pty Ltd, Richmond, Victoria (AU)

(21) Appl. No.: 17/054,392

(22) PCT Filed: May 10, 2019
(86) PCT No.: PCT/AU2019/050440

§ 371 Date: Nov. 10, 2020

(30) Foreign Application Priority Data
May 10, 2018 (AU) 2018901607

(51) Int. Cl. F21V 21/084; F21V 23/00; F21V 29/70; F21L 4/04; F21V 5/04; F21V 23/06; F21V 29/10

(52) U.S. Cl. CPC F21V 21/084; F21V 23/003; F21V 29/70; F21L 4/04; F21Y 2115/10; F21V 23/001; F21V 23/06; F21V 29/10; F21V 5/04

(57) ABSTRACT

The present disclosure provides a head lamp comprising: a light source; a power supply for powering the light source; and a chassis adapted to hold the light source, said chassis being receivable within a body formed from a resiliently flexible material, said body being adapted to be secured to a wearer's head.

### FIELD OF THE INVENTION

The present invention relates to head lamps (also known as head torches) that are adapted to be secured to a person's head. Typically, such head lamps are utilised when performing activities in low-light, such as bike riding, running, hiking, and other similar activities, albeit the present invention should not be limited to a particular field of use.

### BACKGROUND OF THE INVENTION

Head lamps (or head torches) are widely known and used in low-light environments to improve visibility. For example, head lamps may be worn when bike riding, running, hiking, reading, or whenever increased illumination is desired.

Head lamps commonly comprise an elongate flexible strap and a separate body securable to the strap, which body houses a light source and a power source. Typically, the light source comprises a small light globe or one or more light emitting diodes (LEDs) and the power source comprises one or more replaceable or rechargeable batteries. One such head lamp is disclosed in United States patent publication no. 2006/0087842.

An object of the present invention is to provide an alternative head lamp that is aesthetically pleasing in design when compared to prior known head lamps, or that at least provides a useful alternative choice for a consumer.

Reference to any prior art in the specification is not an acknowledgment or suggestion that this prior art forms part of the common general knowledge in any jurisdiction or that this prior art could reasonably be expected to be understood, regarded as relevant, and/or combined with other pieces of prior art by a skilled person in the art

### SUMMARY OF THE INVENTION

In a first aspect, the present invention provides a head lamp comprising:

a light source;

a power supply for powering the light source; and

a chassis adapted to hold the light source and the power supply, said chassis being overmoulded with a resiliently flexible material to define a body adapted to be secured to a wearer's head.

Preferably, the body is adapted to be secured to the wearer's head by at least partially encircling the wearer's head.

The body may be selectively reconfigurable between a first, open, configuration and a second, closed, configuration. In the closed configuration, the body is preferably in the form of a loop that may encircle the wearer's head so as to be securable thereto. In the open configuration, the body is preferably elongate in overall form and includes a first end and a second opposite end. In an alternative embodiment, the body may be formed as a single continuous closed loop, wherein the closed loop is not reconfigurable to an open configuration in which the body has first and second ends.

In an embodiment comprising a selectively reconfigurable body, the first and second ends of the body are preferably selectively connectable to one another to define the second, closed, configuration of the body. The first end may include a connector element, and the second end may include a receptacle configured to receive the connector element in the closed configuration of the body. Preferably, a release mechanism is selectively triggerable to release the connector element from the receptacle. The connector element may be mounted to the chassis or integrally formed with a part of the chassis, and may extend from the chassis.

The connector element may be a charging connector configured to receive power from an external power source to thereby recharge the power supply. The charging connector may be a USB connector, such as a USB-A connector. The connector element may therefore have a substrate with electrical contacts mounted to it.

The body preferably includes an adjustment mechanism that is selectively adjustable to finely adjust a size of the body such that the body is adapted to be secured to a variety of differing head sizes. Preferably, the adjustment mechanism is configured to adjust a length (or circumference) of the loop defined by the body in the closed configuration. The adjustment mechanism may be separate from the first and second ends of the body. The body may include strap portions and the adjustment mechanism may have one or more connectors that engage the strap portions and set a length of the body by a frictional engagement between the connector(s) and the strap portions. Alternatively, the adjustment mechanism may include one or more posts being receivable in a respective one or more apertures in the strap portions to set a length of the body. Further alternatively, the adjustment mechanism may include one or more clasps, buckles, clips, clamps, or other fasteners configured to engage the strap portions to set a length of the body.

The chassis preferably defines a casing. The casing may form an internal void for receiving and housing the light source and the power supply. The casing may also form the connector element. The chassis or casing may be curved about a longitudinal axis so that the chassis or casing approximates the curvature of the wearer's forehead.

The light source is preferably one or more light emitting diodes (LEDs). The light source may emit light through one or more optical elements that are preferably mounted to the casing to form part of the chassis. The one or more optical elements may be switchable or interchangeable by the wearer as desired, for example via a switch, to adjust the properties of the emitted light. The one or more optical elements may be one or more lenses. The one or more lenses may be lenticular lenses that may be combined with holographic film.

In an embodiment, the light source comprises a first set of LEDs comprising: a first LED configured as a main “spotlight” LED; a second pair of LEDs configured as “wide angle” LEDs; and a third LED configured as a red-coloured LED that may not disrupt the wearer's natural night vision capabilities. The light source may also comprise a second set of LEDs comprising four “reading light” LEDs of relatively lower brightness than the first LED and which are configured to aid the wearer in reading. The first set of LEDs may be mounted to the chassis so as to provide illumination from a front face of the body. The second set of LEDs may be mounted to the chassis so as to provide illumination from a lower front face of the body generally below the front face.

The casing preferably includes a first opening located in the front face of the body, which may receive an optical element, wherein the first set of LEDs preferably emit light through the first opening. The casing also preferably includes a second opening located in the lower front face of the body, which may receive another optical element, wherein the second set of LEDs preferably emit light through the second opening. These openings are not overmoulded by the resilient flexible material.

The body preferably includes one or more selectively actuable buttons configured to actuate the light source. The one or more buttons may be mounted to the chassis. In one embodiment, there may be a first button configured to toggle the light source on/off and a second button configured to cycle through a plurality of operating modes of the light source when the light source is toggled on by the first button. The plurality of operating modes of the light source may include: a first mode in which only the first LED is illuminated at a first brightness level; a second mode in which only the first LED is illuminated at a second brightness level relatively brighter than the first brightness level; a third mode in which only the first LED is illuminated at a third brightness level relatively brighter than the second brightness level; a fourth mode in which only the second pair of LEDs is illuminated; a fifth mode in which only the third LED is illuminated; and a sixth mode in which only the second set of LEDs is illuminated. The first and/or second buttons may be located on the front face of the body. Alternatively, the first and/or second buttons may be located on an upper surface of the body or on a lower surface of the body. The plurality of operating modes may also be triggered by, for example, pressing and temporarily holding on the first and/or the second button.

The power supply may be mounted to or integral with the chassis. The power supply is preferably one or more rechargeable batteries, such as one or more lithium-ion or lithium-polymer batteries. The one or more batteries may be curved. The power supply may be removable or non-removable from the head lamp.

The resiliently flexible material that defines the body is preferably a silicone rubber. The material may be moulded over a substrate, for example a stretchable fabric, which extends around a portion of the body. The silicone rubber may be translucent and/or transparent, or may include translucent and/or transparent portions. Advantageously, in this embodiment, the light source may be configured so as to direct light through the translucent and/or transparent portions of the body. Preferably, the translucent and/or transparent portions may be arranged around the body such that the head lamp provides side and/or rear illumination for the wearer. The light source may include one or more light pipes that are configured to direct the light from the light source to the translucent and/or transparent portions of the body.

The body may include one or more portions that are formed to have a different hardness when compared to other portions of the body. For example, the portion of the body located about the chassis may be formed to have first hardness, and portions of the body not located about the chassis may be formed to have a second hardness, wherein the first hardness is greater than the second hardness. For example, the first hardness may be 60 Shore A, and the second hardness may be 40 Shore A. Advantageously, this allows for the portion of the body located about the chassis to be relatively rigid, and for the other portions of the body not located about the chassis to be relatively less rigid (i.e. more flexible), to thereby be relatively more comfortable for the wearer.

In a second aspect, the present invention provides a head lamp comprising:

a light source;

a power supply for powering the light source; and

a chassis adapted to hold the light source and the power supply, said chassis being receivable within a body formed from a resiliently flexible material, said body being adapted to be secured to a wearer's head.

The chassis preferably defines a casing having an internal void for housing the light source and the power supply.

The casing is preferably receivable within a cavity defined in the body. The casing may be removably receivable within the cavity to, for example, allow for re-charging of the power supply when the casing has been removed from the cavity. Advantageously, the casing may be removably receivable so as to allow an alternative casing to be received within the cavity. The alternative casing may, for example, include a different light source and/or power supply. The different light source may, for example, comprise a different arrangement of LEDs. In an alternative embodiment, the casing may be non-removably secured within the cavity, for example, by using adhesive.

The cavity is preferably accessible by an opening defined in the body. A cross-section of the casing is preferably larger than the opening, such that portions of the body adjacent the opening act to releasably secure the casing within the cavity. Preferably, the cavity is shaped and dimensioned so as to be similar to the shape and dimension of the casing. A rear surface of the casing may include a protrusion that is shaped and dimensioned so as to be similar to the shape and dimension of the opening, such that the protrusion closes the opening when the casing is located within the cavity.

In a third aspect, the present invention provides a head lamp comprising:

a light source;

a power supply for powering the light source; and

a chassis adapted to hold the light source, said chassis being overmoulded with a resiliently flexible material to define a body adapted to be secured to a wearer's head.

The power supply may be mounted to the body and include an electrical connection that electrically connects the power supply to the light source. The electrical connection may comprise one or conductors that extend from the power supply to the light source. The one or more conductors may be located on or within the body.

In a fourth aspect, the present invention provides a head lamp comprising:

a light source;

a power supply for powering the light source; and

a chassis adapted to hold the light source, said chassis being receivable within a body formed from a resiliently flexible material, said body being adapted to be secured to a wearer's head.

The chassis is preferably receivable within a cavity defined in the body. The chassis may be removably receivable within the cavity.

The chassis may also include a heatsink configured to remove or dissipate heat from the light source. The chassis preferably defines a casing that includes the light source and the heatsink. The chassis or casing may be pivotable with respect to a portion of the body so that a direction of light emanating from the light source may be selectively adjusted. Preferably, the direction of the light source is selectively manually adjusted by the wearer.

The chassis or casing is preferably rotatably or pivotably connected on opposite sides thereof to respective arms located within the body. The arms are preferably fixed within the body. An end of each arm may include a projection or detent that is configured to seat in one of a plurality of complementary recesses provided in the chassis or casing so as to releasably set and lock a position of the chassis or casing with respect to the arms. The projection or detent is generally resiliently flexible such that a minimum force is required to move the projection or detent from one of the plurality of recesses to an adjacent one of the plurality of recesses to thereby adjust the position of the chassis or casing with respect to the arms.

Advantageously, due to the resiliently flexible nature of the body, the chassis or casing may be pivoted up to approximately ±20° with respect to the arms without significantly impacting the fit and feel of the body located about the wearer's head.

The power supply may be removably mountable to the body. The power supply includes an electrical connection that is configured to electrically connect the power supply to the light source. The electrical connection preferably electrically connects to one or more conductors that extend within the body and are electrically connected to the light source so as to provide electrical energy from the power supply to the light source. The power supply may be mounted to any part of the body. For example, the power supply may be mounted to a rear portion of the body such that the power supply is located generally adjacent a rear surface of the wearer's head when the head lamp is worn. The power supply may alternatively be mounted generally adjacent the heatsink, and preferably in such a manner that there is a space between the heatsink and the power supply so as to allow air to flow over the heatsink to cool the heatsink.

The head lamp according to the first, second, third, and fourth aspects of the invention may also include any one or more of the features described above in relation to any other aspect of the invention.

As used herein, except where the context requires otherwise, the term “comprise” and variations of the term, such as “comprising”, “comprises” and “comprised”, are not intended to exclude further additives, components, integers or steps.

Further aspects of the present invention and further embodiments of the aspects described in the preceding paragraphs will become apparent from the following description, given by way of example and with reference to the accompanying drawings.

### BRIEF DESCRIPTION OF THE DRAWINGS

FIG. 1 is a perspective view of a head lamp according to an embodiment of the invention;

FIG. 2 is another perspective view of the head lamp of FIG. 1;

FIG. 3 is another perspective view of the head lamp of FIG. 1 in an open configuration;

FIG. 4A is a rear exploded view of the head lamp of FIG. 1;

FIG. 4B is a front exploded view of the head lamp of FIG. 1;

FIG. 5A is a close-up rear exploded view of certain components of the head lamp of FIG. 1;

FIG. 5B is similar to FIG. 5A from the front;

FIG. 6A is a close-up view of a connector that connects opposite ends of the head lamp of FIG. 1;

FIG. 6B is similar to FIG. 6A from the other side;

FIG. 7A is a rear perspective view of the head lamp of FIG. 1 showing an adjustment mechanism set at a first length;

FIG. 7B is similar to FIG. 7A, with the adjustment mechanism set at a second length different from the first length;

FIG. 8A is a perspective view of a head lamp according to an alternative embodiment of the invention;

FIG. 8B is similar to FIG. 8A, but the chassis is removed from the body;

FIG. 8C is similar to FIG. 8B, but is from a rear perspective;

FIG. 8D is an exploded view of the chassis shown in FIGS. 8B and 8C;

FIG. 9A is a perspective view of a head lamp according to a further alternative embodiment of the invention;

FIG. 9B is another perspective view of the head lamp of FIG. 9A;

FIG. 10A is an exploded view of the head lamp of FIG. 9A;

FIG. 10B is similar to FIG. 10A, but is from a front perspective;

FIG. 11A is a rear perspective view of the head lamp of FIG. 9A, but the power supply is removed from the body;

FIG. 11B is similar to FIG. 11A, but the power supply is mounted to the body;

FIG. 12 is a close-up perspective view of the chassis showing arms connected to opposite longitudinal ends of the chassis;

FIG. 13 is similar to FIG. 12, but is a part sectional view showing the connection between the chassis and one of the arms;

FIG. 14A is similar to FIG. 12, but is a side view showing the chassis in a first position with respect to the arms; and

FIG. 14B is similar to FIG. 14A, but shows the chassis pivoted to a second position with respect to the arms.

### DETAILED DESCRIPTION OF THE EMBODIMENTS

It will be understood that the invention disclosed and defined in this specification extends to all alternative combinations of two or more of the individual features mentioned or evident from the text or drawings. All of these different combinations constitute various alternative aspects of the invention.

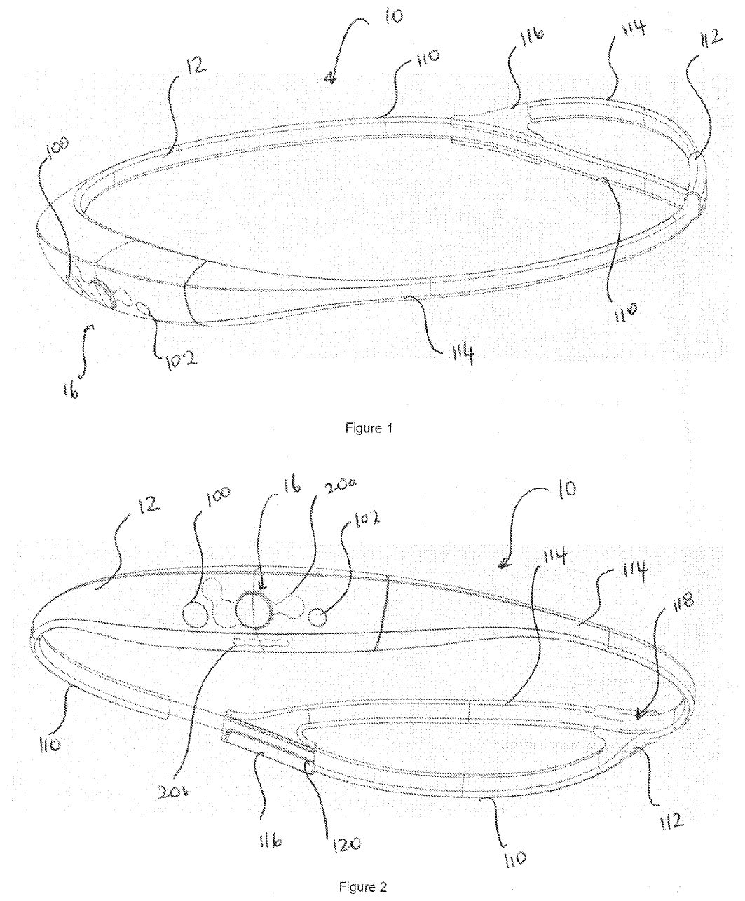

Referring to FIGS. 1 and 2, there is shown a head lamp 10 according to an embodiment of the invention. The head lamp 10 may be worn by a wearer in a low-light environment to improve visibility. For example, the head lamp 10 may be worn by the wearer when bike riding, hiking, reading, or whenever increased illumination is desired.

The head lamp 10 comprises a body 12 formed from a resiliently flexible material in the form of silicone rubber. A person skilled in the art would appreciate however that a variety of other materials may be used to form the resiliently flexible body or a combination of materials. Advantageously, the body 12 is adapted to be secured to the wearer's head by at least partially encircling the wearer's head when worn by the wearer.

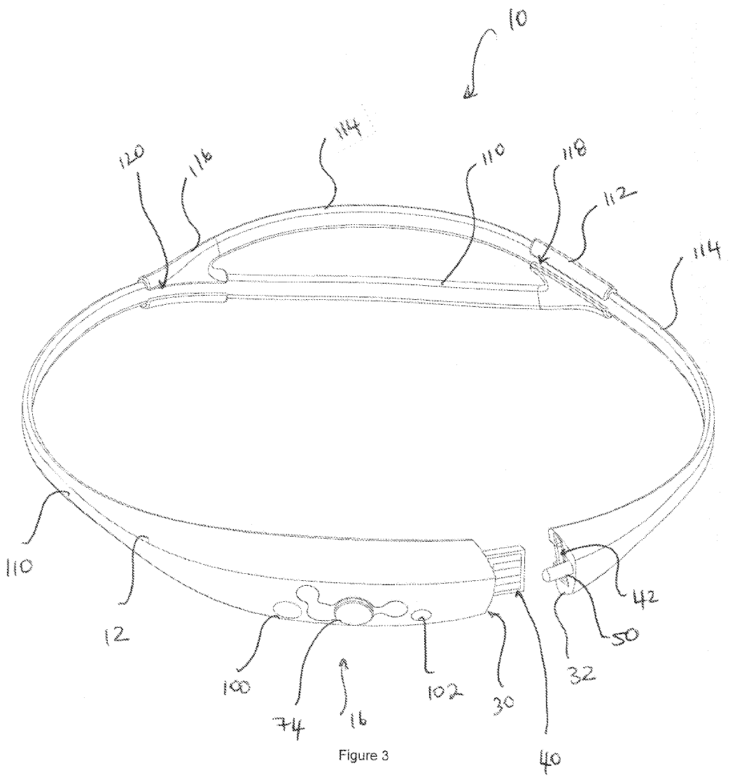

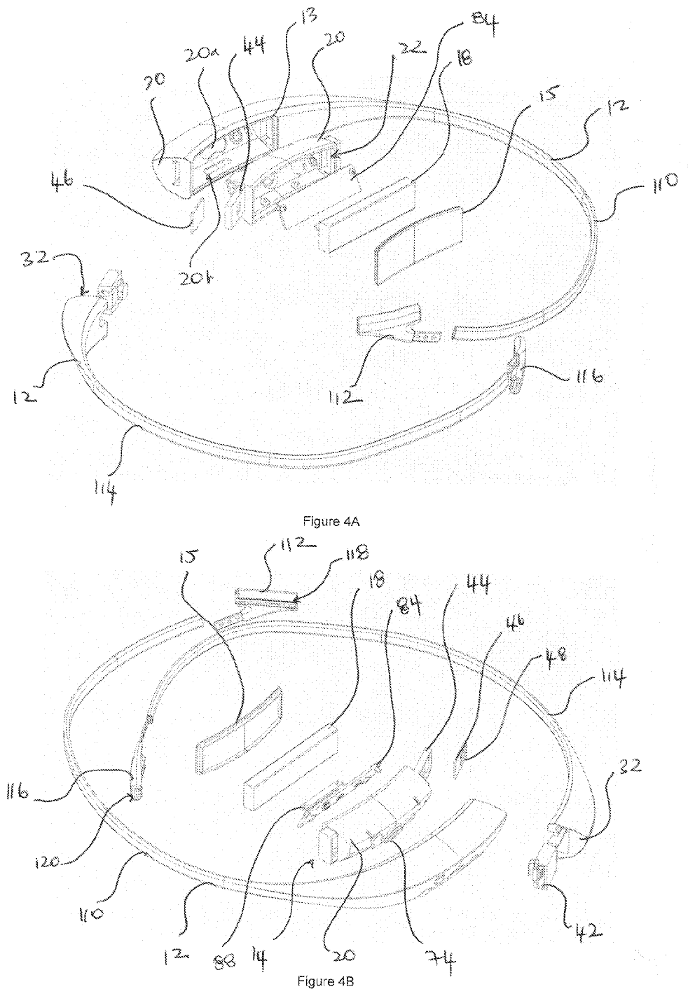

The body 12 is selectively reconfigurable by the wearer between a first, open, configuration (FIG. 3) and a second, closed, configuration (FIGS. 1 and 2). In the closed configuration, the body 12 is in the form of a closed loop that is adapted to encircle the wearer's head when worn so as to be securable thereto by a friction fit. In the open configuration, the body 12 appears elongate in overall form and includes at least a first end 30 and a second opposite end 32 (FIG. 3). The first and seconds ends 30, 32 are selectively connectable to one another to define the second, closed, configuration of the body 12 in the form of the loop, as is shown in FIGS. 1 and 2.

The body 12 may be reconfigured between the open (FIG. 3) and closed configurations (FIGS. 1 and 2) as desired by the wearer. Advantageously, the head lamp 10 may be donned in either of the open or closed configurations. In the open configuration, the power supply 18 of the head lamp 10 may also be recharged, as is discussed in greater detail below. When donning the head lamp 10 in the closed configuration, the wearer may simply pull down the body 12 until the body 12 is comfortably secured about the wearer's head by a friction fit, which is possible due to the resiliently flexible nature of the body 12. When donning the head lamp 10 in the open configuration, the wearer may locate at least a portion of the body 12 about the wearer's head so as to at least partially encircle the wearer's head, and thereafter connect the first and second ends 30, 32 of the body 12 so that the body 12 is reconfigured to the closed configuration in the form of the closed loop secured about the wearer's head by a friction fit. As is described below, the body 12 also includes an adjustment mechanism that is selectively adjustable by the wearer to finely adjust a size of the body 12 such that the body 12 is adapted to be secured to a variety of differing head sizes.

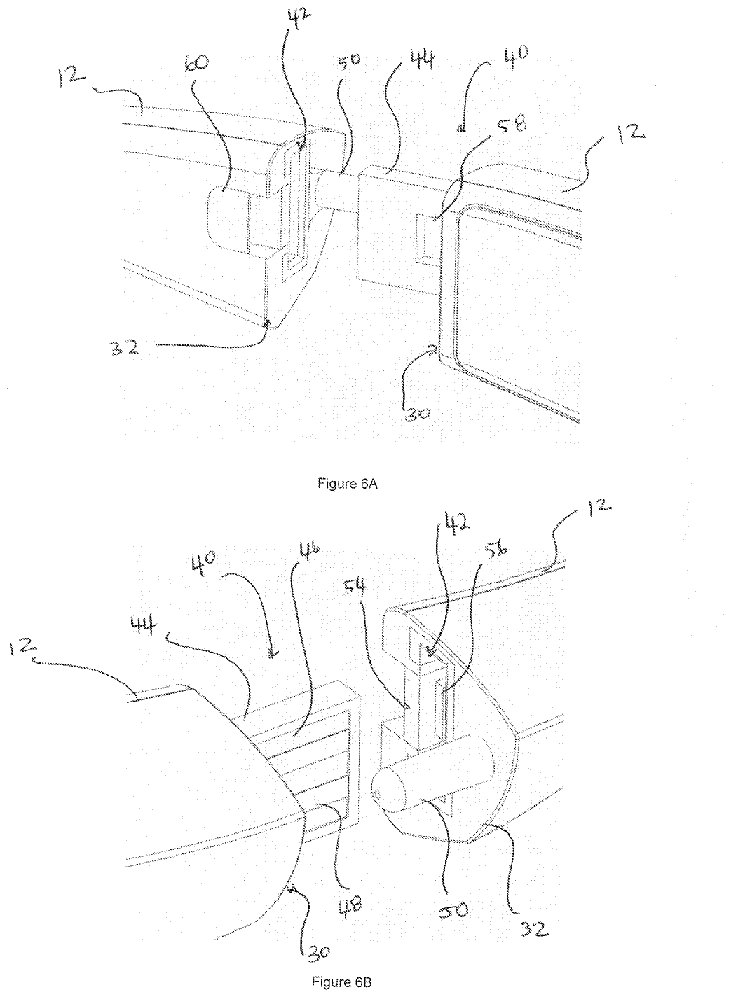

Referring to FIGS. 3 and 6A, 6B, the first end 30 of the body 12 includes a connector element 40 that is releasably received within a complementary receptacle 42 located in the second end 32 of the body 12. As is shown in FIG. 6A, the connector element 40 has a generally rectangular body 44 in cross-section and is mounted to and extends outwardly from the first end 30 in the direction of the longitudinal axis of the body 12. The receptacle 42 includes a generally rectangular cross-section complementary to the cross-section of the connector element 40.

In addition to the receptacle 42, the second end 32 of the body 12 includes a projecting pin 50. The projecting pin 50 projects outwardly from the second end 32 of the body 12 in a direction generally parallel to a longitudinal axis of the body at the second end 32. The projecting pin 50 has a circular cross-section. When in the closed configuration of the body 12, the projecting pin 50 is located in a complementary generally circular recess (not shown) located in the first end of the body 12.

As is explained above, the first and second ends 30, 32 of the body are selectively connectable to one another via the connector element 40 to define the second, closed, configuration of the body shown in FIGS. 1 and 2. The connector element 40 is releasably connected to and secured within the receptacle 42 in the closed configuration, and may be released via a selectively triggerable release mechanism. Firstly, the connector element 40 is releasably secured within the receptacle 42 via a resiliently flexible rectangular tab 54 (FIG. 6B) located within the receptacle 42. The resiliently flexible tab 54 comprises a generally rectangular detent 56 adapted to engage within a complementary generally rectangular recess 58 (FIG. 6A). Recess 58 is located on an underside when the connector element 40 is received within the receptacle 42. A selectively actuable trigger in the form of a push button 60 is located at the second end 32 of the body 12 in an outer surface generally adjacent the receptacle 42. When in the closed configuration of the body 12, the push button 60 may be pushed inwardly toward the receptacle 42 to thereby pivot at least a portion of the resiliently flexible tab 54 away from the connector body 44. This pivots the detent 56 out of engagement within the recess 58. Once the detent 56 is removed from the recess 58, the connector body 44 may be removed from the receptacle 42 by pulling and the body 12 is thereafter reconfigured to the first, open, configuration.

Advantageously, the connector element 40 is a charging connector in the form of a USB-A connector that includes a USB connector body 44 and a substrate 46 with electrical contacts 48 (FIG. 6B). The USB connector body 44 is configured to be releasably connected to an external power source (not shown) in the open configuration of the body 12 so as to receive power from the external power source to thereby recharge the power supply 18. The power supply 18 is also connected to the USB connector 40. As such, the USB connector 40 advantageously performs the dual functions of recharging the power supply 18 and closing the body 12 as desired by the wearer to form the closed configuration of the body in the form of the closed loop adapted to be secured about the wearer's head.

The head lamp 10 further comprises a chassis 14 (FIGS. 5A and 5B) located within the body 12 and adapted to hold a light source 16 and a power supply 18 for powering the light source 16. The chassis 14 includes a rigid casing 20 having a generally trapezoidal cross-section with curved sides. The casing 20 is also slightly curved along a longitudinal axis to approximate the curvature of the wearer's forehead. The casing 20 has a rear opening 22 to create an internal void which the light source 16 and the power supply 18 are received and mounted. The casing 20 also forms the connector body 44. The chassis 14 also includes the substrate 46 and lenses, to be described below.

In the illustrated embodiment, the chassis 14 is overmoulded with the resiliently flexible silicone rubber to define the body 12 adapted to be secured to the wearer's head. After overmoulding, the chassis 14 becomes integral with and non-removable with respect to the body 12. In an alternative embodiment, the chassis 14 may alternatively be removably received within a cavity defined in the body 12, or may be fixedly secured within the cavity by an adhesive. In either embodiment and with particular reference to FIGS. 1 and 2, the body 12 is sleek and streamlined in overall form and does not include, for example, a protruding light source, as is common in prior art designs (such as in United States Patent Publication no. 2006/0087842 mentioned above). Advantageously, the light source 16, the power supply 18, and various other components described below, are all located within the resiliently flexible body 12, which is adapted to be secured to the wearer's head.

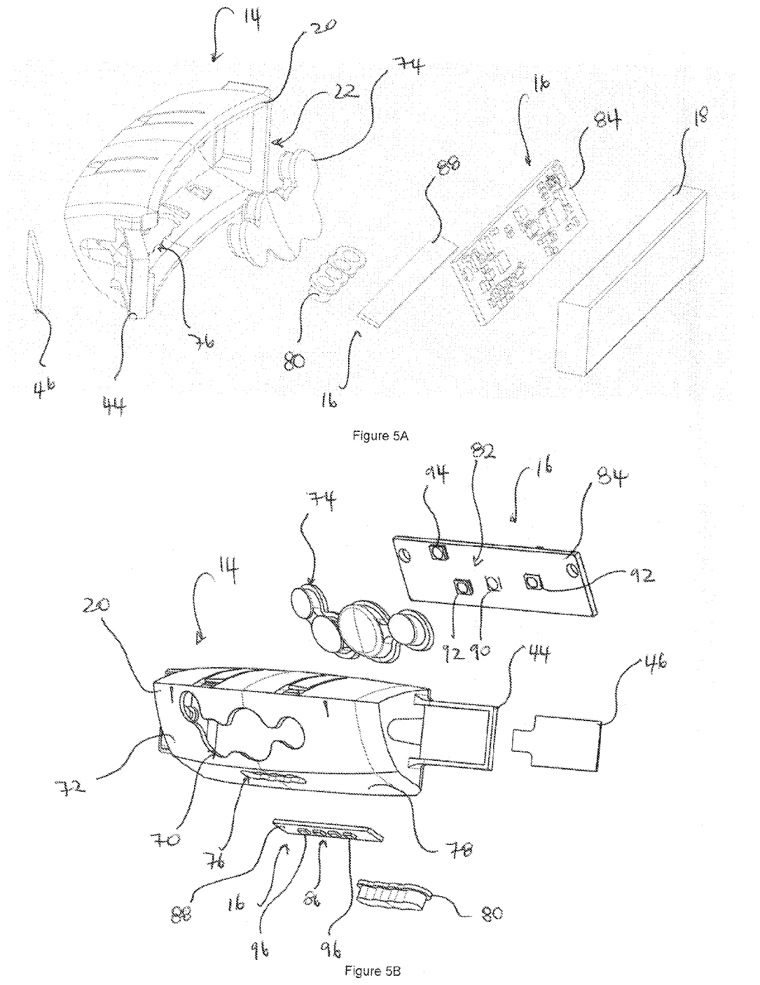

Referring to FIG. 5B, the casing 20 includes a front opening 70 in a front face 72 through which a first lens arrangement 74 is received and mounted. The casing 20 also includes a lower front opening 76 in a lower front face 78 generally below the front face 72. A second lens arrangement 80 is received and mounted in the lower front opening 76. The first and second lens arrangements 74, 80 are configured to refract light from the light source 16 in the manner described below. The body 12 also includes a front opening 20a in a front face thereof and lower front opening 20b (FIG. 4A) a lower front face thereof, the openings 20a, 20b being shaped and dimensioned to respectively match the shape and dimension of the front openings 70, 76 (FIG. 5B) defined in the casing 20.

The power supply 18 (FIG. 5A) for powering the light source 16 may be in the form of a rechargeable lithium-polymer battery. A person skilled in the art would appreciate however that an alternative rechargeable battery, such as a lithium-ion battery, may also be suitable for powering the light source 16.

The light source 16 comprises a plurality of light emitting diodes (LEDs). Specifically, the light source 16 comprises a first set of LEDs 82 (FIG. 5B) located on a first printed circuit board (PCB) 84. The first PCB 84 is received within and mounted to the casing 20 such that the first set of LEDs 82 emit light through the first lens arrangement 74. There is also a second set of LEDs 86 (FIG. 5B) located on a second PCB 88. The second PCB 88 is received within and mounted to the casing 20 so that second set of LEDs 86 emit light through the second lens arrangement 80.

Referring to FIG. 5B, the first set of LEDs 82 has a first LED 90 that is a main “spotlight” LED, for illuminating directly ahead. There is also a second pair of LEDs 92 that operate as “wide angle” LEDs for providing peripheral light. A third

LED 94 is configured as a red-coloured LED, which can be used so as not to disrupt the wearer's natural night vision capabilities. This first set of LEDs 82 emit light through the first lens arrangement 74 in the front opening 20a in the front face of the body 12.

The second set of LEDs 86 has four “reading light” LEDs 96. These are of relatively lower brightness to aid the wearer in reading. The second set of LEDs 86 emit light through the second lens arrangement 80 in the lower front opening 20b in the lower front face of the body 12.The lower front face of the body 12 is angled generally downwardly and forwardly such that the four “reading light” LEDs 96 emit focused light downwards at a natural reading position for the wearer.

Also mounted to the chassis 14 and depressible through an outer surface of the body 12 are first and second selectively actuable buttons 100, 102 (FIG. 2) configured to actuate and control the light source 16 via the power supply 18. The first and second buttons 100, 102 are located in the front face of the body 12 such that the first button 100 is located on a first side of the front opening 20a and the second button 102 is located on a second opposite side of the front opening 20a. The first button 100 is configured to toggle the light source 16 on/off and the second button 102 is configured to cycle through a plurality of operating modes of the light source 16 when the light source 16 is toggled on by the first button 100.

The plurality of operating modes of the light source 16 include: a first mode in which only the first LED 90 is illuminated at a first brightness level; a second mode in which only the first LED 90 is illuminated at a second brightness level relatively brighter than the first brightness level; a third mode in which only the first LED 90 is illuminated at a third brightness level relatively brighter than the second brightness level; a fourth mode in which only the second pair of “wide angle” LEDs 92 is illuminated; a fifth mode in which only the third red-coloured LED 94 is illuminated; and a sixth mode in which only the four “reading light” LEDs 96 are illuminated.

The body 12 also includes an adjustment mechanism that is selectively adjustable to finely adjust a size of the body 12 such that the body 12 is adapted to be secured to a variety of differing head sizes. As will be described below, the adjustment mechanism is configured to adjust a length (or circumference) of the closed loop defined by the body in the closed configuration.

Referring initially to FIG. 4A, it can be seen that a first length portion 110 of the body 12 extends from the first end 30 and approximately defines a half loop that is terminated in a first generally Y-shaped connector 112. A second length portion 114 of the body 12 extends from the second end 32 and approximately defines another half loop that is terminated in a second generally Y-shaped connector 116.

Construction of the head lamp 10 will now be described. The substrate 46 is mounted to the USB connector body 44 and the first and second lens arrangements 74, 80 are inserted into the casing 20 to form the chassis 14. The chassis and connector 112 are then spaced apart in a mould and overmoulded with a resiliently flexible silicon rubber to form the first portion 110 of the body 12. After overmoulding, the first and second PCBs 84, 88 including the respective first and second sets of LEDs 82, 86, and the rechargeable battery 18 are then mounted to casing 20 via a rear opening 13 (FIG. 4A) formed during the overmoulding process. The rear opening 13 is then closed by a rear panel 15, which is formed from a rigid plastic and which is fixed in place by an adhesive. Alternatively, the rear panel 15 may be overmoulded with a silicone layer, and then fixed in place by an adhesive or other fastener, such as a screw or a snap fastener. The rear panel 15 has a generally rectangular cross-section and is slightly curved along a longitudinal axis thereof. The rear panel 15 is preferably secured to the body 12 by ultrasonic welding or adhesive to close off the rear opening 13. Although not illustrated in the figures, the rear panel 15 may include a relatively soft pad located on an outer surface so as to be located between the rear panel 15 and the wearer's forehead. The soft pad may be thermally insulating and may provide comfort to the wearer. The second portion 114 is also formed by spacing an insert that forms the receptacle 42 away from the other Y-shaped connector 116. These parts are overmoulded with a resilient flexible material to form the second portion 114 of the body.

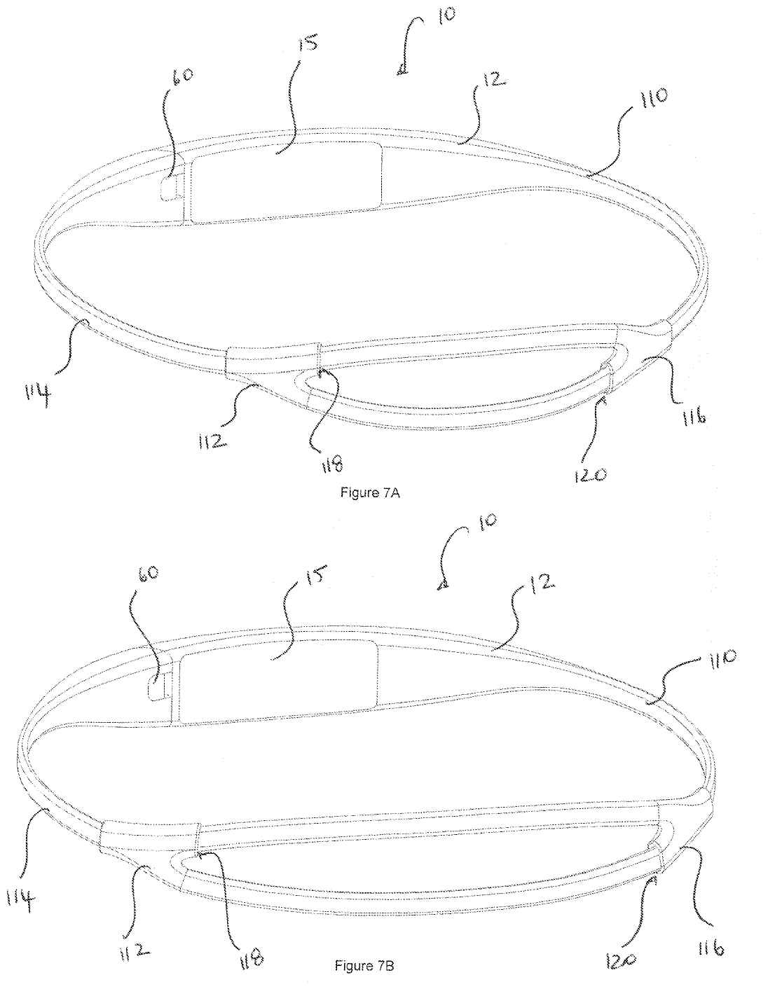

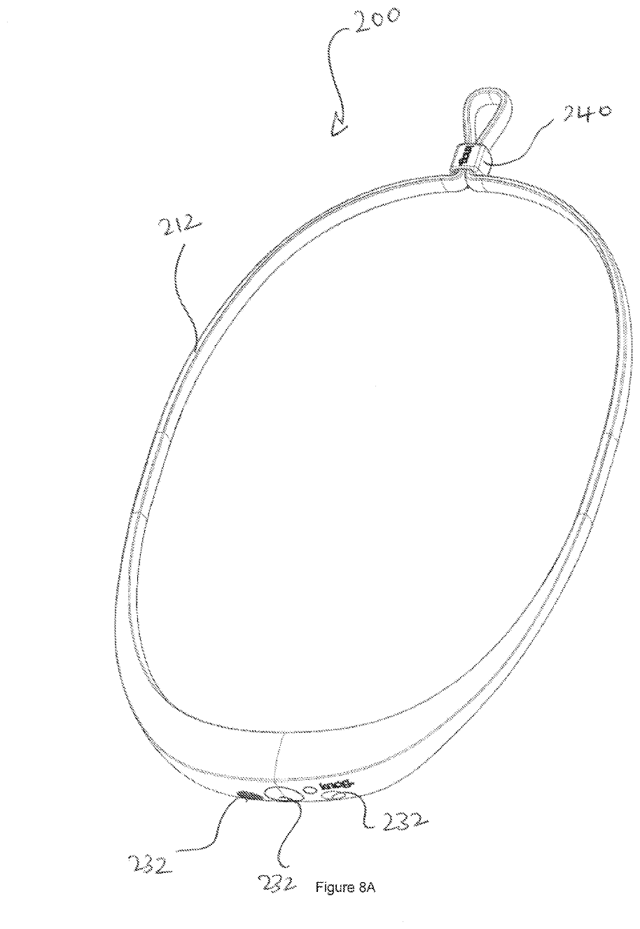

Now referring to FIGS. 2, 3, and 4B, it can be seen that the first Y-shaped connector 112 defines a first generally rectangular channel 118 that slidably receives and grips via friction a portion of the second length portion 114. Additionally, it can also be seen that the second Y-shaped connector 116 defines a second generally rectangular channel 120 that slidably receives and grips via friction a portion of the first length portion 110. The connection of the first portion 110 to the second portion 116 forms the body 12. Advantageously, each of the Y-shaped first and second connectors 112, 116 can be separately selectively slid along the respective second and first length portions 114, 110 to overcome the friction between the first and second channels 118, 120 and the respective second and first length portions 114, 110 to adjust an overall length (or circumference) of the closed loop defining the body 12 in the closed configuration of the head lamp 10. Such an adjustment can be seen in FIGS. 7A and 7B. In FIG. 7A, the first and second Y-shaped connectors 112, 116 have been manipulated by the wearer and slid along the respective second and first length portions 114, 110 such that the first and second connectors 112, 116 are separated by a first length to define a first overall length of the body 12 adapted to be secured to the wearer's head. In FIG. 7B, the first and second connectors 112, 116 have been further manipulated by the wearer and further slid along the respective second and first length portions 114, 110 such that the first and second connectors 112, 116 are separated by a second length greater than the first length mentioned above to define a second overall length that is less than the first overall length shown in FIG. 7A (thereby providing a tighter fit on the wearer's head as compared to the first overall length shown in FIG. 7A).

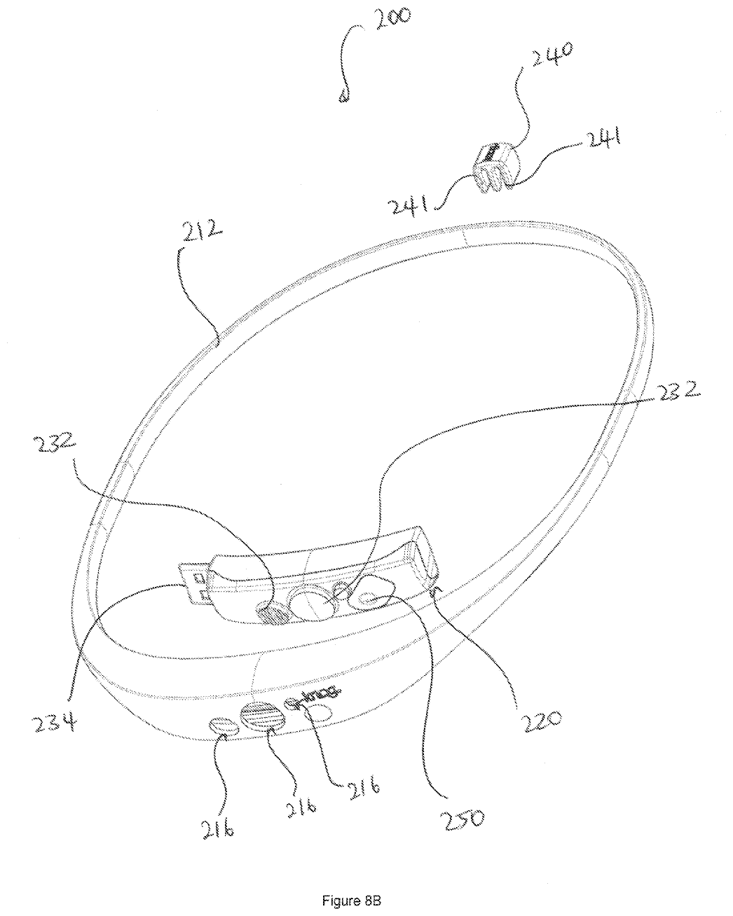

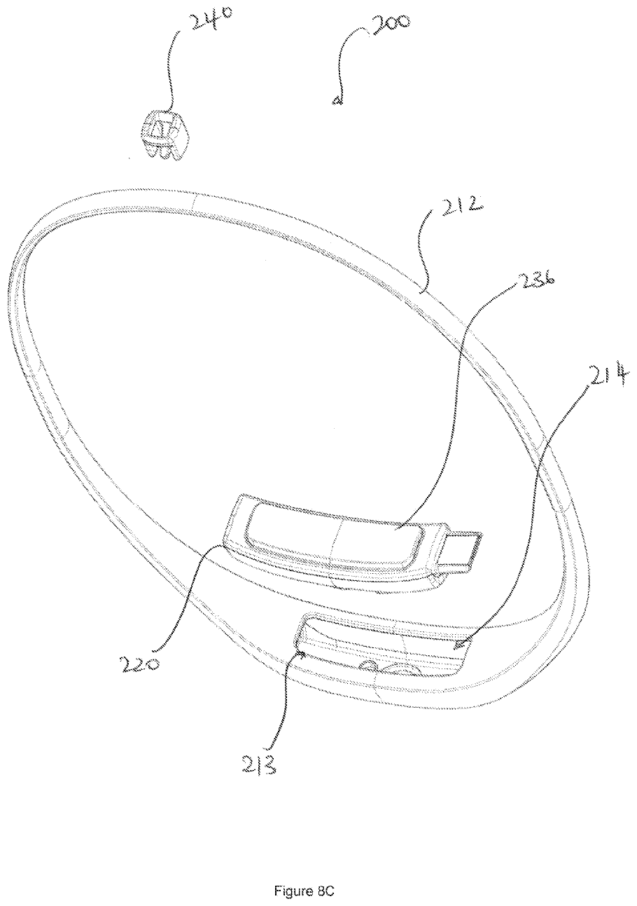

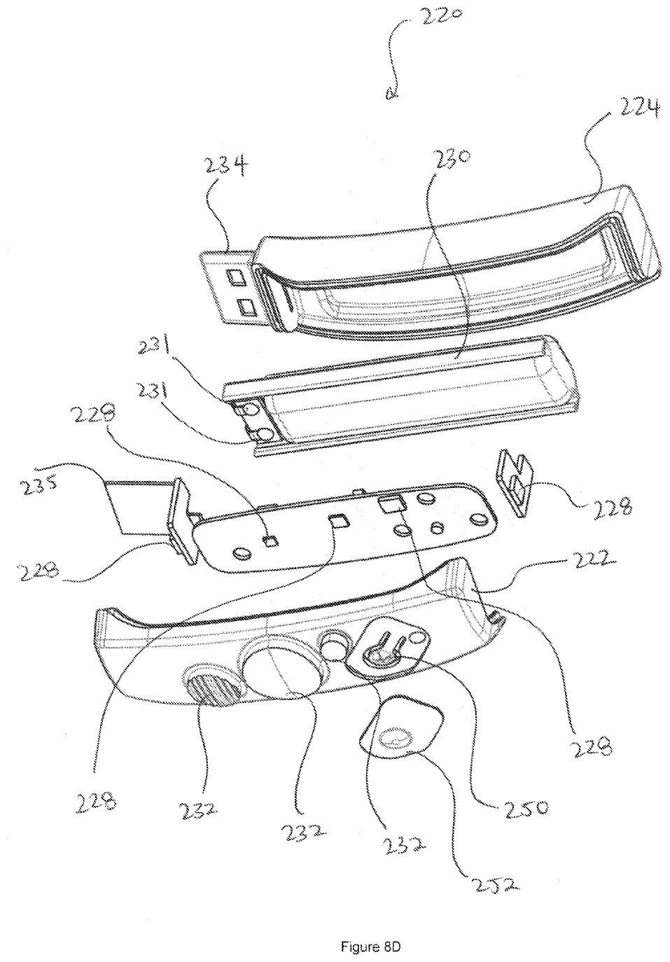

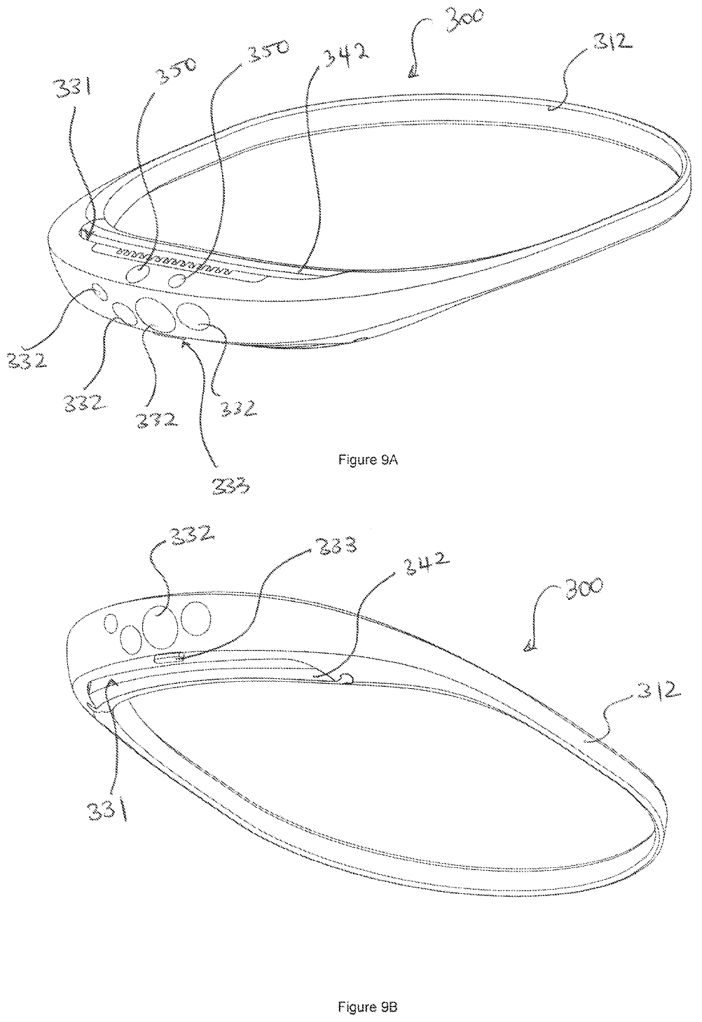

Referring to FIGS. 8A to 8D, there is shown an alternative embodiment of the invention in the form of a head lamp 200. The head lamp 200 is similar in many respects to the head lamp 10. However, the head lamp 200 comprises a body 212 that is formed as a single continuous closed loop, wherein the closed loop is not reconfigurable to an open configuration having first and second ends that are selectively connectable (like the head lamp 10).

The body 212 is formed by overmoulding a removable steel insert (not shown) with a resiliently flexible silicone rubber. As a result of the overmoulding process, the body 212 is formed to include a cavity 214 (FIG. 8C) near a front region thereof, and front openings 216 (FIG. 8B) adjacent the cavity 214. The cavity 214 is accessible by a rear opening 213 (FIG. 8C) in a rear surface of the body 212.

The head lamp 200 also comprises a casing 220 (FIG. 8B) having a generally rectangular cross-section. Referring to FIG. 8D, the casing 220 includes a first, or front, part 222, and second, or rear part 224. The front part 222 is configured to mount a light source in the form of a PCB 226 containing LEDs 228. The PCB 226 contains three front LEDs 228 located on a front surface of the PCB 226, and two side LEDs 228 arranged at opposite longitudinal ends of the PCB 226 and mounted generally perpendicular to the front LEDs 228 located on the front surface of the PCB 226. The three front LEDs 228 comprise a main “spotlight” LED, a “wide angle” LED, and a red-coloured LED that is suitable for night-time reading. The two side LEDs 228 arranged at opposite longitudinal ends of the PCB 226 are configured to direct light through translucent and/or transparent portions (not shown) of the body 212. Specifically, the body 212 includes one or more light pipes (not shown), which are preferably transparent, and which are configured to direct light from the side LEDs 228 to the translucent and/or transparent portions of the body. Advantageously, the translucent and/or transparent portions are arranged about the body such that the head lamp 200 provides side and/or rear illumination for the wearer (in addition to the front illumination provided by the front LEDs 228).

The rear part 224 of the casing 220 is configured to mount a power supply in the form of a rechargeable lithium-ion or lithium-polymer battery 230. The front part 222 includes three generally circular lens elements 232 that are each configured to refract light from the front LEDs 228. The front part 220 also includes a push button 250 configured to control the operation of the LEDs 228, and a push button seal 252 for covering and sealing the push button 250 to prevent ingress from water and other particles.

The rear part 224 includes a USB-A connector body 234 having a substrate 235 with electrical contacts for receiving power to recharge the battery 230 via battery contacts 231. The front part 222 is fixedly connected to the rear part 222 to form the casing 220. As is shown in the figures, the casing 220 is curved about a longitudinal axis so as to approximate the curvature of the wearer's forehead.

The front openings 216 (FIG. 8B) in the body 212 are shaped and dimensioned to receive the three generally circular lens elements 232 that protrude from a front surface of the casing 220. Similarly, the cavity 214 (FIG. 8C) in the body 212 is shaped and dimensioned to receive the casing 220. Specifically, the cavity 214 is shaped and dimensioned so as to be similar to the shape and dimension of the casing 220. However, the casing 220 has a cross-section which is larger than the opening 213, such that portions of the body 212 adjacent the opening 213 act to releasably secure the casing 220 within the cavity 214. As is shown in FIG. 8C, the rear part 224 of the casing 220 includes a generally rectangular protrusion 236 that is shaped and dimensioned so as to be similar to the shape and dimension of the opening 213, such that the protrusion 236 closes the opening 213 when the casing 220 is located within the cavity 214.

Advantageously, the casing 220 is removably receivable within the cavity 214 to, for example, allow for re-charging of the battery 230 when the casing 220 is removed from the cavity 214. Additionally, the casing 220 may be removably receivable so as to allow for an alternative casing (not shown) to be received within the cavity. The alternative casing may, for example, include a different light source and/or power supply to the casing 220.

The head lamp 200 also includes an adjustment mechanism in the form a clip 240 configured to adjust a length (or circumference) of the loop defined by the body 212. Referring to FIG. 8A, to adjust the length of the loop, a wearer may pinch together two portions of the loop generally opposite the portion of the body 212 containing the casing 220, and thereafter attach the clip 240 to the pinched portions of the loop. The clip 240 includes two adjacent channels 241 (FIG. 8) that are adapted to respectively receive and hold, by friction, the two portions of the loop, as is shown in FIG. 8A.

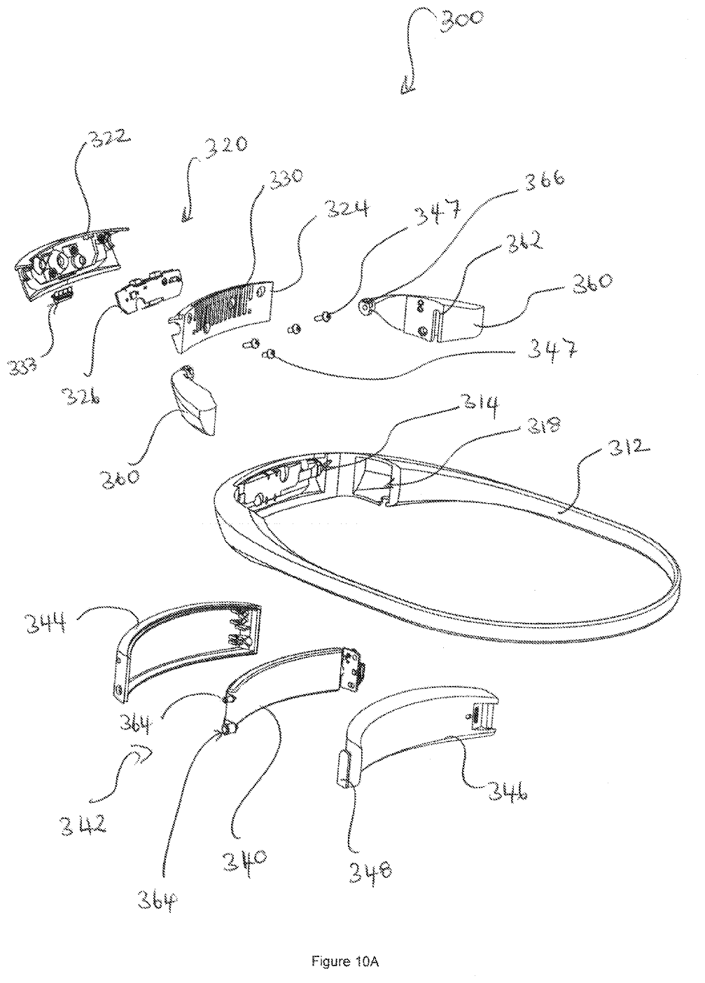

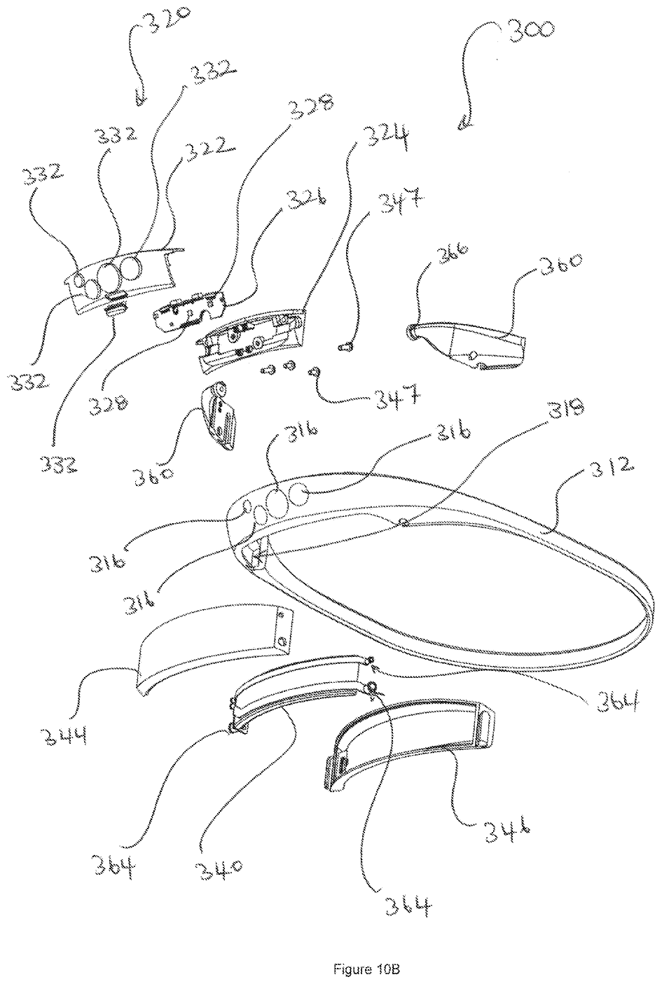

Referring to FIGS. 9 to 14, there is shown a further alternative embodiment of the invention in the form of a head lamp 300. The head lamp 300 is similar in many respects to the head lamps 10, 200, but includes the further features described below.

The head lamp 300 comprises a body 312 that is formed as a single continuous closed loop, wherein the closed loop is not reconfigurable to an open configuration having first and second ends that are selectively connectable (like the head lamp 10).

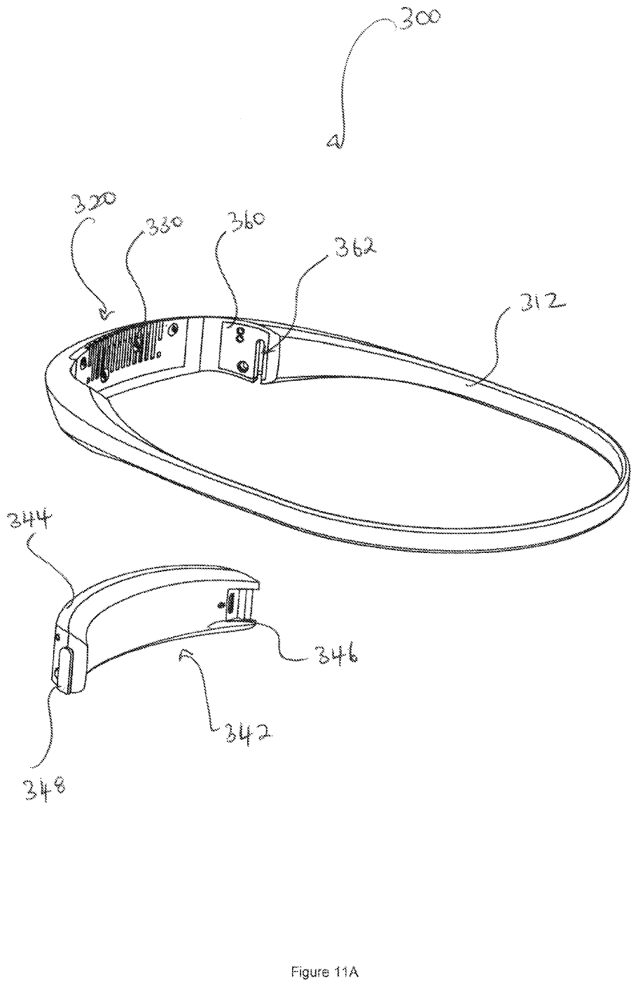

The body 312 is formed by overmoulding a removable steel insert (not shown) with a resiliently flexible silicone rubber. As a result of the overmoulding process, the body 312 is formed to include a casing cavity 314 (FIG. 10A), front openings 316 (FIG. 10B), and arm cavities 318 (FIG. 10A).

Referring to FIG. 10A, the casing cavity 314 is configured to receive a casing 320 having a generally rectangular cross-section. The casing 320 includes a first, or front, part 322, and second, or rear part 324. The front part 322 is configured to mount a light source in the form of a PCB 326 containing LEDs 328 (FIG. 10B). The rear part 324 includes a heatsink 330 configured to remove heat from the PCB 326 and LEDs 328. The front part 322 and the rear part 324 are fixedly connected by screws 347 to form the casing 320. The screws 347 are also configured to precisely locate and mount the PCB 326 in the casing 320. As is shown in the figures, the casing 320 is curved about a longitudinal axis so as to approximate the curvature of the wearer's forehead. The casing 320 is secured within the cavity 314 by an adhesive.

In an alternative non-illustrated embodiment, the casing 320 may be removably mounted within the cavity 314. In a further alternative non-illustrated embodiment, the front part 322 of the casing 320 and arms 360 (described later) may be overmoulded so as to become integral and non-removable with respect to the body 312. After the overmoulding process, the PCB 326 and the rear part 324 may be fixed to the front part 322 via the screws 347.

Referring to FIG. 10B, the front part 322 includes four generally circular lens elements 332 and a generally rectangular lens element 333 having curved ends, each of the lens elements 332, 333, being configured to refract light from the LEDs 328. The head lamp 300 includes the same LED lighting arrangement and features as the head lamp 10 described above and shown in FIG. 5B. The front part 320 also includes two generally circular selectively actuable push buttons 350 (FIG. 9A), 352 configured to control the operation of the LEDs 328, also in the same manner as described above in relation to the head lamp 10. The front openings 316 in the body 312 are shaped and dimensioned to receive the four generally circular lens elements 332 and the generally rectangular lens element 333.

Referring to FIGS. 10A and 10B, the body 312 is configured to releasably mount a power supply in the form of a rechargeable lithium-ion or lithium-polymer battery 340. The battery 340 is located in the generally rectangular housing 342 comprised of a front part 344 and a rear part 346, the front and rear parts 344, 346 being fixedly connected.

As is shown in the figures, the housing 342 is curved about a longitudinal axis to approximate the curvature of the wearer's head. Accordingly, the battery 340 is also curved about its longitudinal axis to accommodate the curvature of the battery housing 342. By utilising a curved battery 340, the amount of power provided by the battery 340 located within the casing 320 can be maximised, whilst also maintaining the sleek and streamlined form of the body 312.

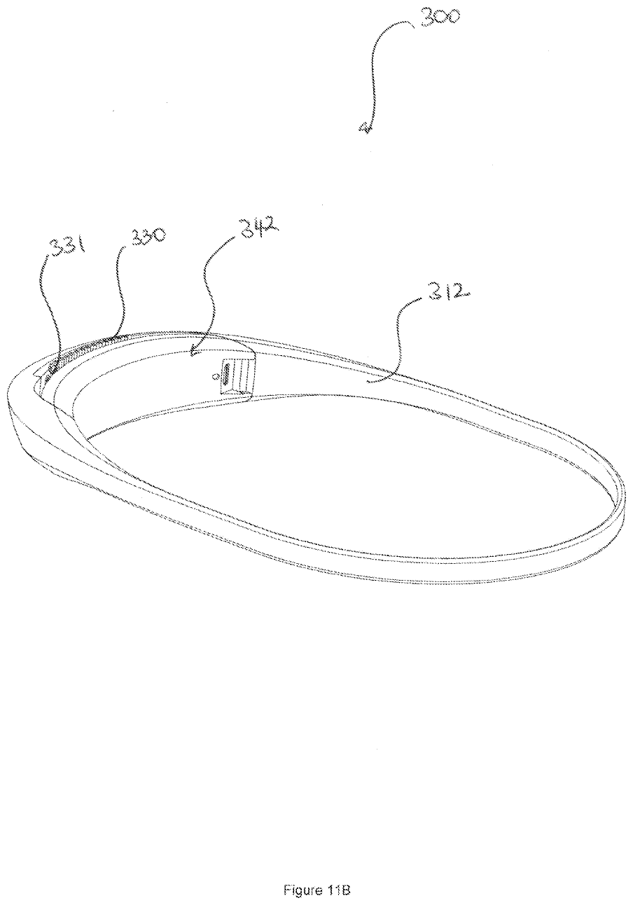

The rear part 346 of the battery housing 342 includes generally pill-shaped protrusions 348 (FIG. 11A) that extend generally transversely to the longitudinal axis of the housing 342. The protrusions 348 are configured to be releasably seated in complementary recesses 362 located in the arms 360, described in detail below. The battery housing 342 is therefore removable from the body 312 to allow, for example, the battery 340 to be re-charged and/or for the battery housing 342 to be replaced by another battery housing (not shown) so that the head lamp 300 can be used generally continuously. As is shown in FIGS. 9A, 9B, and 11B, when the battery housing 342 is mounted to the body 312 via the arms 360, there is a space 331 between the heatsink 330 and the battery housing 342 so as to allow air to flow over the heatsink 330 to cool the heatsink 330.

Referring again to FIGS. 10A and 10B, the battery housing 342 includes two pairs of generally circular spring contacts 364 that project outwardly from opposite ends of the housing 342. The spring contacts 364 are configured to electrically connect to flexible conductors (not shown) located in the body 312. The flexible conductors extend within the body 312 and connect to the PCB 326 containing the LEDs 328 to thereby supply electrical energy from the battery 340 to power the LEDs 328.

Advantageously, in the head lamp 300, the casing 320 is manually pivotable with respect to a portion of the body 312, specifically, the arms 360, so that the direction of the light provided by the LEDs 228 may be selectively adjusted.

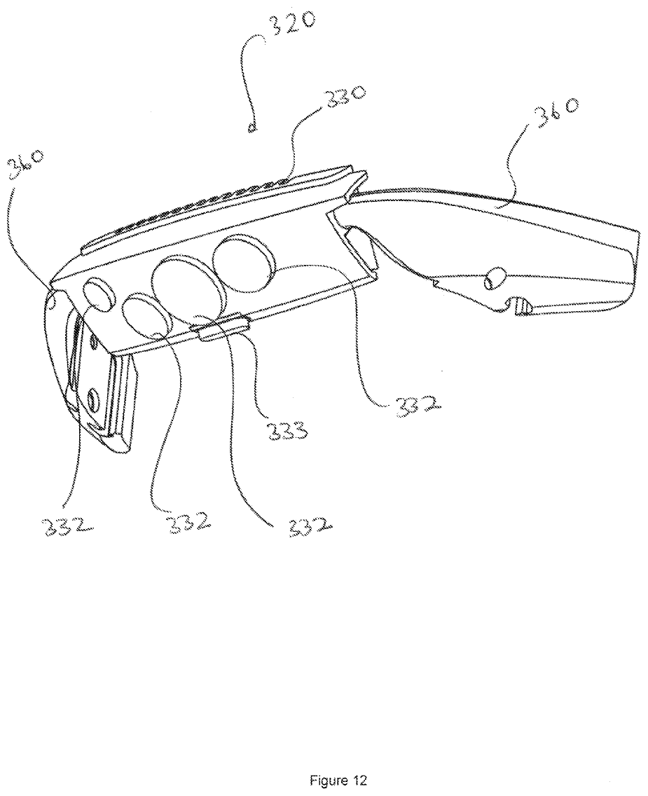

As is explained above, the body 312 includes pair of curved arms 360. A portion of each arm 360 is fixed within a respective arm cavity 318 (FIG. 10A) located in the body 312 generally adjacent opposite longitudinal ends of the casing cavity 314. Each arm 360 includes a generally circular extension 366 (FIG. 10A) at an end thereof that is configured to interface with the casing 320 (FIG. 12) in the manner described below.

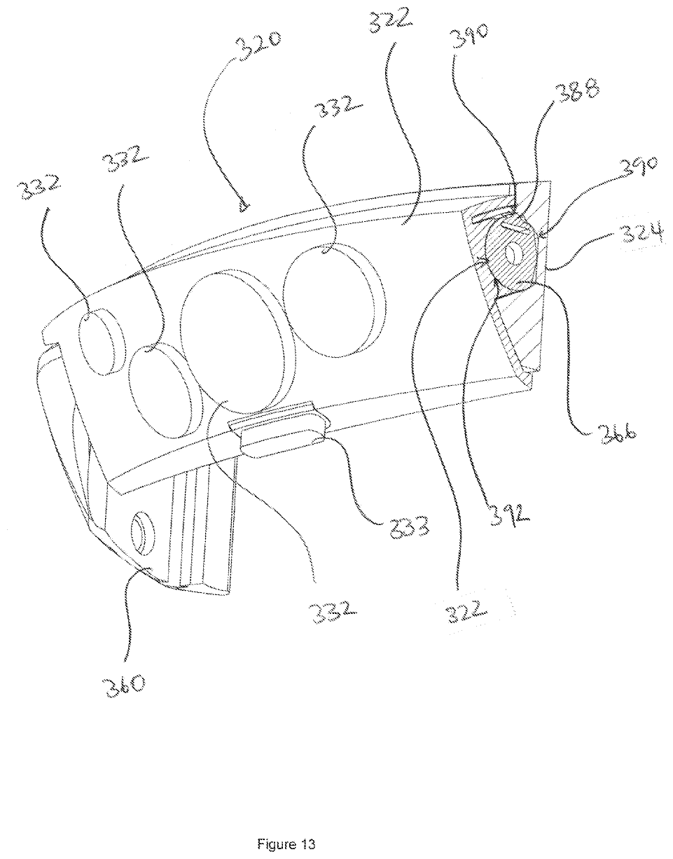

Referring to the partial cross-section shown in FIG. 13, the generally circular extension 366 includes a projection or detent 388 having a generally triangular cross-section. The triangular projection 388 is resiliently flexible and is configured to seat within one of a plurality of complementary recesses 390 defined in an outer side wall of the casing 320, in particular, the outer side wall of the rear part 324 of the casing. The projection 388 and the recesses 390 are configured such that, when the projection 388 is located in a recess 390, the position of the casing 320 with respect to the arms 360 is set and releasably locked.

The generally circular extension 366 also acts as a bearing surface for the casing 320 to pivot or rotate thereabout. Specifically, the extension 366 includes a generally circular outer surface 392, a portion of which interfaces with a complementary part-circular cut-out 394 located in an outer wall of the front part 322 of the casing 320. In this manner, the casing 320 can pivot or rotate about the circular extension 366 according to the position of the projection 388 within the recesses 390.

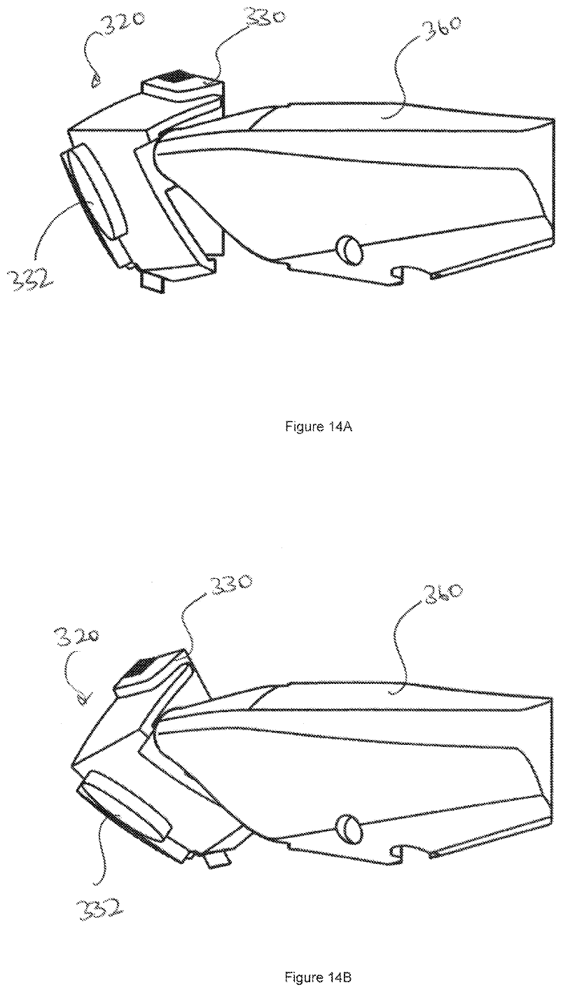

As is described above, the projection 388 is generally resiliently flexible such that a minimum force is required to move the projection 388 from one of the plurality of recesses 390 to an adjacent one of the plurality of recesses 390 to thereby adjust the position of the casing 320 with respect to the arms 360. The recesses 390 are defined in the outer wall of the rear part 324 of the casing 320 in such a manner so as to provide the ability for the casing 320 to be pivoted up to approximately ±20° with respect to the arms 360. FIGS. 14A and 14B illustrate the range of pivoting of the casing 320 with respect to the arms 320. Advantageously, due to the resiliently flexible nature of the body 312, the casing 320 may be pivoted without significantly impacting the fit and feel of the body 312 located about the wearer's head. To pivot the casing 320, the wearer needs to merely grasp the portion of the body 312 in which the casing 320 is located and rotate the casing 320 to the desired position. The casing 320 will be releasably locked in position when the projection 388 is located in one of the plurality of recesses 390.

Advantageously, by selectively manually adjusting the position of the casing 320 with respect to the arms 360, the direction of the light provided by the LEDs 328 may be adjusted.

Although not illustrated, the body 312 of the head lamp 300 may be adjusted in length to suit different wearers by having an adjustment mechanism, such as the mechanisms described above in relation to the head lamps 10 and 200.

As is described above, the present invention provides head lamps 10, 200, and 300 that are aesthetically pleasing and generally sleek in overall form. The head lamps include resiliently flexible bodies in which the various components of the head lamps may be located and which are adapted to be secured to the wearer's head by at least partially encircling the wearer's head.

It will be understood that the invention disclosed and defined in this specification extends to all alternative combinations of two or more of the individual features mentioned or evident from the text or drawings. All of these different combinations constitute various alternative aspects of the invention.

1. A head lamp comprising:
a light source;
a power supply for powering the light source; and
a chassis adapted to hold the light source, said chassis being receivable within a body formed from a resiliently flexible material, said body being adapted to be secured to a wearer's head.

2. The head lamp of claim 1, wherein the body is adapted to be secured to the wearer's head by at least partially encircling the wearer's head.

3. The head lamp of claim 1, wherein the chassis defines a casing having an internal void for housing the light source and the power supply.

4. The head lamp of claim 3, wherein the casing is removably receivable within a cavity defined in the body and is accessible by an opening defined in the body.

5. (canceled)

6. The head lamp of claim 4, wherein a cross-section of the casing is larger than the opening, such that portions of the body adjacent the opening act to releasably secure the casing within the cavity.

7. The head lamp of claim 4, wherein the cavity is shaped and dimensioned so as to be similar to the shape and dimension of the casing.

8. The head lamp of claim 4, wherein a rear surface of the casing includes a protrusion that is shaped and dimensioned so as to be similar to the shape and dimension of the opening, such that the protrusion closes the opening when the casing is located within the cavity.

9. The head lamp of claim 1, wherein the chassis defines a casing having an internal void for housing the light source.

10. The head lamp of claim 9, wherein the casing includes a heatsink configured to remove heat from the light source.

11. The head lamp of claim 9, wherein the casing is pivotable with respect to a portion of the body so that a direction of light emanating from the light source is selectively adjustable.

12. The head lamp of claim 11, wherein the casing is pivotably connected on opposite sides thereof to respective arms located within the body.

13. The head lamp of claim 12, wherein an end of each arm includes a projection that is configured to seat in one of a plurality of recesses provided in the casing so as to releasably set and lock a position of the casing with respect to the arms.

14. The head lamp of claim 13, wherein the projections are resiliently flexible such that a minimum force is required to move the projection from one of the plurality of recesses to an adjacent one of the plurality of recesses to thereby adjust the position of the casing with respect to the arms.

15. The head lamp of claim 12, wherein the casing is pivotable up to approximately ±20° with respect to the arms.

16. The head lamp of claim 10, wherein the power supply is removably mountable to the body.

17. The head lamp of claim 10, wherein the power supply includes an electrical connection configured to electrically connect to one or more conductors located within the body, wherein the one or more conductors extend within the body and are electrically connected to the light source so as to provide electrical energy from the power supply to the light source.

18. The head lamp of claim 16, wherein the power supply is mountable to the body generally adjacent the heatsink such that there is a space between the heatsink and the power supply, wherein the space allows for air to flow over the heatsink to cool the heatsink.

19. The head lamp of claim 1, wherein the body includes an adjustment mechanism configured to selectively adjust a circumference of a loop defined by the body, wherein the loop is configured to at least partially encircle the wearer's head so as to secure the body thereto.

20. A head lamp comprising:
a light source;
a power supply for powering the light source; and
a chassis adapted to hold the light source and the power supply, said chassis being overmoulded with a resiliently flexible material to form a body adapted to be secured to a wearer's head.

21. The head lamp of claim 20, wherein the body is adapted to be secured to the wearer's head by at least partially encircling the wearer's head.

22. The head lamp of claim 20, wherein the body is selectively reconfigurable between a first, open, configuration and a second, closed, configuration, wherein in the closed configuration the body is in the form of a loop, and wherein in the open configuration the body is elongate in overall form and includes a first end and a second opposite end, and wherein the first end is releasably connectable to the second end.

23. The head lamp of claim 22, wherein the first end includes a connector element, and the second end includes a receptacle configured to receive the connector element in the closed configuration of the body.

24. The head lamp of claim 23, wherein the connector element is a charging connector configured to receive power from a power source to thereby recharge the power supply.

25. The head lamp of claim 23, wherein the connector element extends from the chassis.

26. The head lamp of claim 22, wherein the body includes an adjustment mechanism configured to selectively adjust a circumference of the loop defined by the body in the closed configuration.

27. The head lamp of claim 1, wherein the light source comprises one or more light emitting diodes (LEDs).

28. The head lamp of claim 27, wherein the one or more LEDs emit light through one or more optical elements mounted to the chassis.

29. The head lamp of claim 27, wherein the body includes one or more selectively actuatable buttons configured to control the light source.

30. The head lamp of claim 17, wherein the power supply is mountable to the body generally adjacent the heatsink such that there is a space between the heatsink and the power supply, wherein the space allows for air to flow over the heatsink to cool the heatsink.

31. The head lamp of claim 20, wherein the light source comprises one or more light emitting diodes (LEDs).

32. The head lamp of claim 31, wherein the one or more LEDs emit light through one or more optical elements mounted to the chassis.
